(19) United States
(12) Patent Application Publication
(10) Pub. No.: US 2009/0252014 A1
(43) Pub. Date: Oct. 8, 2009

(54) OPTICAL DRIVE CAPABLE OF REPLAYING OPTICAL CARRIERS WITH HIGH BIREFRINGENCE

(76) Inventor: Johannes Paulus Hubertus Van De Ven, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/373,746

(22) PCT Filed: Jul. 5, 2007
(86) PCT No.: PCT/IB07/52627

§ 371 Date: Jan. 14, 2009

(30) Foreign Application Priority Data
Jul. 17, 2006 (EP) 06117305.0

(51) Int. Cl. G11B 7/00

(52) U.S. Cl. 369/100; G9B/7

(57) ABSTRACT

The invention relates to an optical drive for reading information from an optical disk (1) with a high birefringence. A radiation beam (5) has a modulated read power level of frequency F1. A polarizing beam splitter (PBS; 6) guides the reflected beam (8) from the disk (1) towards a photo detector (10) that outputs optical response signals (RS). The optical response signals (RS) are converted to optical response parameters (RP) that are compared with a predetermined optical response parameter reference values (RP_ref). If a sufficient deviation (Δ) is present it is indicative of an optical feedback from the beam splitting means (PBS; 6) towards to the radiation source (4). The processing means (52) can then change the first modulator frequency (F1) of the radiation beam (5) to a second modulator frequency (F2) so as to decrease the optical feedback. The invention provides a relatively simple yet effective way of compensating for a high birefringence value on an optical carrier wherefrom information is replayed.

### FIELD OF THE INVENTION

The present invention relates to an optical drive for reading information from an associated optical carrier capable of replaying optical carriers with high birefringence. The invention also relates to a corresponding method for operating an optical drive and corresponding processing means for controlling an optical drive.

### BACKGROUND OF THE INVENTION

Optical recording and replaying on optical carriers such as optical disks of the CD (compact disk), DVD (digital versatile disc) or BD (Btu-Ray disk) format can in general be performed with optical drives utilizing polarizing optics or non-polarizing optics.

Optical drives with non-polarizing optics have a relatively simple design and are accordingly robust in their performance. Such optical drives are for example not influenced by birefringence from the optical disk. However, for optical drives with non-polarizing optics the power delivered to the optical disk and in turn reflected to the detection photodiodes is more difficult to control. This problem is particularly important if information is to be written on the optical disk as power control is essential for reliable recording on an optical disk. For this reason most optical drives apply polarizing optics to facilitate more efficient power control in the optical system consisting of the optical drive and optical carrier.

Optical drives with a laser as irradiation source inherently has a polarized light source and appropriate optical elements are then provided for defining and controlling the optical path with respect to the polarized light. Optical elements include polarizing beam splitters, half wavelength plates, quarter wavelength plates etc. The optical carrier or disk itself can negatively influence the polarized light impinging on the optical disk if the birefringence of the disk is above the specified level for the optical disk in question. The birefringence of the optical disk can thereby introduce an unacceptably high distortion of the polarized, reflected light from the optical disk resulting in a possible optical power loss in the return path towards the photo detection means of the optical drive. Consequently, the read-out signal from the optical disk can be of a reduced quality or even impossible to decode resulting in a complete failure of the optical drive.

The birefringence of the optical disk typically originates from the production process where short cycle times and/or fast cooling times in the moulding process can introduce an anisotropic behavior in the optical parameters (i.e. the refractive index) of the moulded optical disk. Normally, the optical disk is injection moulded in polycarbonate (PC), the injection moulding can introduce shrinkage, flow lines, and inclusions in the substrate. Usually, the birefringence is more severe near the outer diameter. During recording/replaying of the optical disk, the fast rotation in the optical drive can also increase the strain in the optical disk and in turn aggravate the birefringence of the optical disk.

The problem of unacceptably high birefringence of optical disks is commonly known in art and a range of technical solutions are available. It should be mentioned that the problem with optical disks having birefringence values beyond the appropriate specifications, so-called “out-of-spec” disks, is generally an increasing phenomena due to the highly competitive trend towards low-cost optical disks.

US patent application 2005/259553 discloses a technical solution where a birefringence correcting element (see element 5a in FIG. 1 and FIG. 14) is inserted in the optical path of the optical drive in order to correct for birefringence in the optical disk. The correcting element comprises a material with mono-axial refractive index anisotropy and the correcting element is located before an objective lens of the optical drive. In one embodiment, the correcting element is divided into four regions by two straight lines passing an optical axis and intersecting each other at right angles. Each of the four regions is radially divided into four sub-regions by three circles centered at the optical axis. By this optical design the phase difference that is produced when light is reflected by the birefringent disk can be offset or cancelled by the phase difference that is produced when the light is transmitted through the correcting element. However, the number of regions has to be quite high in order to provide a complete or near-complete correcting effect. This is therefore a solution which is expensive to implement into mass-scale production of optical drives.

Hence, an improved optical drive would be advantageous, and in particular a more efficient and/or reliable optical drive would be advantageous.

### SUMMARY OF THE INVENTION

Accordingly, the invention preferably seeks to mitigate, alleviate or eliminate one or more of the above mentioned disadvantages singly or in any combination. In particular, it may be seen as an object of the present invention to provide an optical drive that solves the above mentioned problems of the prior art with optical carriers having relatively high birefringence values.

This object and several other objects are obtained in a first aspect of the invention by providing an optical drive for reading information from an associated optical carrier, the optical drive comprising:

a radiation source capable of emitting a radiation beam having a read power level modulated with a first modulator frequency (F1), said radiation beam being optically arranged to impinge on the associated optical carrier,

polarizing beam splitting means (PBS) arranged for guiding a reflected beam from the carrier towards photo detection means, said photo detection means being capable of outputting optical response signals (RS), and

processing means for processing said optical response signals (RS) received from the photo detection means into one or more optical response parameters (RP), said processing means comprising comparison means arranged for monitoring if a optical response parameter (RP) is deviating from a pre-determined optical response parameter reference value (RP_ref), said deviation being indicative of an optical feedback from the beam splitting means (PBS) towards to the radiation source, the processing means further being adapted for changing the first modulator frequency (F1) of the radiation beam to a second modulator frequency (F2) so as to decrease the optical feedback.

The invention is particularly, but not exclusively, advantageous for obtaining an optical drive that provides a relatively simple yet effective way of compensating for a relatively high birefringence value on an optical carrier wherefrom information is replayed. The optical drive compares one or more optical response parameters (RP) with reference values so as to obtain an indication of the birefringence of the optical carrier being replayed, and accordingly the optical drive is capable of modifying the frequency of the radiation beam applied for reading the optical carrier so as to lower the optical feedback resulting from the birefringence of the optical carrier being read.

The invention is furthermore relatively easy to implement in existing optical drive technology as most optical drives already have a reading laser beam that is modulated with a fixed frequency. For electromagnetic shielding purposes (EMC), this frequency has hitherto been kept constant during operation of the optical drive i.e. the optical drive has been designed for a certain fixed modulator frequency. The technical problem with huge birefringence of optical carriers has then been solved by e.g. inserting a correcting optical element in the optical drive as in US patent application 2005/259553, or other corrective means or methods known in the art. Preliminary testing performed by the applicant shows that the majority of the prior art solutions commercially available are also not capable of dealing with relatively large birefringence values as compared to the present invention.

It is to be understood that the meaning of the term “deviation” in the context of the present invention, i.e. the deviation of the optical response parameter (RP) from a pre-determined optical response parameter reference value (RP_ref), can include absolute deviation within a measurement uncertainty and relative deviation within a measurement uncertainty. The deviation can also be understood as a deviation beyond a certain threshold, preferably on a time-averaged basis, in order to discriminate random noise and isolated errors or events.

In one embodiment, the optical response signals (RS) may represents information read from the optical carrier e.g. the optical response signal (RS) could be the high frequency (HF) signal. Thereby, irradiation source used for reading information is applied for measuring the birefringence of the optical carrier being read. The optical response parameter (RP) may then be chosen from the group consisting of: an address locating a position on the optical carrier, an uncorrectable error in an information sequence read from the optical carrier, and an asymmetry value (beta) measured from the optical response signals (RS) from the optical carrier. The advantage is that these parameters are already available for other purposes and accordingly the present invention may relatively easy be implemented. Moreover, the asymmetry value, or equivalents thereof, is a relatively good measure of the birefringence of the optical carrier being replayed.

In alternative embodiment, the optical drive may have comprise an auxiliary radiation source adapted for emitting an auxiliary radiation beam, said beam being optically arranged for impinging on the optical carrier and resulting in a reflected beam towards the photo detection means. In this embodiment, the birefringence of the optical carrier can be assessed without using the irradiation source applied for reading information. Thus, a dedicated light source for measuring birefringence can be installed in the optical drive. Therefore, in this particular embodiment the photo detection means can possible not be applied in reading information from the optical carrier, and accordingly the optical drive may then further comprise auxiliary photo detection means for detection of reflected radiation representing information read from the optical carrier.

In one embodiment often implemented, the second modulator frequency (F2) may be higher than the first modulator frequency (F1). Thus, the first modulator frequency (F1) can be increased in selected steps of 5%, 10%, 15%, or 20%. Alternatively, absolute increments may be applied, such as 5, 10, 15, 20, or 25 MHz. It should be noted that in general, the power dissipation is increasing for increasing modulator frequency due to the capacitive coupling of semiconductor lasers. Thereby, this embodiment is not a preferred choice for power considerations.

Additionally or alternatively, the processing means may be arranged for increasing the modulator frequency (F1; F2) in a feedback loop so to minimize the deviation of an optical response parameter (RP) from a pre-determined optical response parameter reference value (RP_ref). Thereby, a quite effective way of iteratively compensating a larger interval of birefringence values is provided.

In order to manipulate the radiation beam with respect to power, the beam may have a substantially square-wave power profile. Due to the very high frequency some deviations from square-wave will occur in real implementations. The teaching of the present invention is not limited to this power profile but may include a variety of power profiles such as sinusoidal profiles, multi-level stepping profiles, etc. It is however crucial that the power is periodically effectively turned off so as to decrease the optical feedback, as it will be explained in more detail below.

In one embodiment, the radiation beam may be optically arranged for passing the polarizing beam splitting means (PBS) on the optical path towards the optical carrier as this provides a simple optical path for the optical drive.

In a second aspect, the invention relates to processing means for controlling an associated optical drive for reading information from an associated optical carrier, the optical drive comprising:

a radiation source capable of emitting a radiation beam having a read power level modulated with a first modulator frequency (F1), said radiation beam being optically arranged to impinge on the associated optical carrier, and

polarizing beam splitting means (PBS) arranged for guiding a reflected beam from the carrier towards photo detection means, said photo detection means being capable of outputting optical response signals (RS),

the processing means being adapted for processing said optical response signals (RS) received from the photo detection means into one or more optical response parameters (RP), said processing means comprising comparison means arranged for monitoring if an optical response parameter (RP) is deviating from a pre-determined optical response parameter reference value (RP_ref), said deviation being indicative of an optical feedback from the beam splitting means (PBS) towards to the radiation source, the processing means further being adapted for changing the first modulator frequency (F1) of the radiation beam to a second modulator frequency (F2) so as to decrease the optical feedback.

In a third aspect, the invention relates to a method for operating an optical drive for reading information from an optical carrier, the method comprising the steps:

emitting a radiation beam having a read power level modulated with a first modulator frequency (F1), said radiation beam being optically arranged to impinge on the optical carrier,

guiding by polarizing beam splitting means (PBS) a reflected beam from the carrier towards photo detection means, said photo detection means being capable of outputting optical response signals (RS), and

processing said optical response signals (RS) received from the photo detection means into one or more optical response parameters (RP),

monitoring if an optical response parameter (RP) is deviating from a pre-determined optical response parameter reference value (RP_ref), said deviation being indicative of an optical feedback from the beam splitting means (PBS) towards to the radiation source, and

changing the first modulator frequency (F1) of the radiation beam to a second modulator frequency (F2) so as to decrease the optical feedback.

In a fourth aspect, the invention relates to a computer program product being adapted to enable a computer system comprising at least one computer having data storage means associated therewith to operating an optical drive according to the third aspect of the invention.

This aspect of the invention is particularly, but not exclusively, advantageous in that the present invention may be implemented by a computer program product enabling a computer system to perform the operations of the second aspect of the invention. Thus, it is contemplated that some known optical drive may be changed to operate according to the present invention by installing a computer program product on a computer system controlling the said optical recording apparatus. Such a computer program product may be provided on any kind of computer readable medium, e.g. magnetically or optically based medium, or through a computer based network, e.g. the Internet.

The first, second, third and fourth aspect of the present invention may each be combined with any of the other aspects. These and other aspects of the invention will be apparent from and elucidated with reference to the embodiments described hereinafter.

### BRIEF DESCRIPTION OF THE FIGURES

The present invention will now be explained, by way of example only, with reference to the accompanying Figures, where

FIG. 1 is a schematic diagram of an optical drive according to the present invention,

FIG. 2 is a schematic illustration of optical feedback in an optical drive,

FIG. 3 is a simplified diagram of an optical drive according to the present invention,

FIG. 4 is a simplified graph showing the power output of an irradiation source,

FIG. 5 is a schematic diagram of the optical path for an optical drive reading an optical carrier with no birefringence,

FIG. 6 is a schematic diagram of the optical path for an optical drive reading an optical carrier with birefringence,

FIG. 7 is a graph showing the birefringence across an optical carrier,

FIG. 8 is a flow-chart of a method according to the invention.

### DETAILED DESCRIPTION OF AN EMBODIMENT

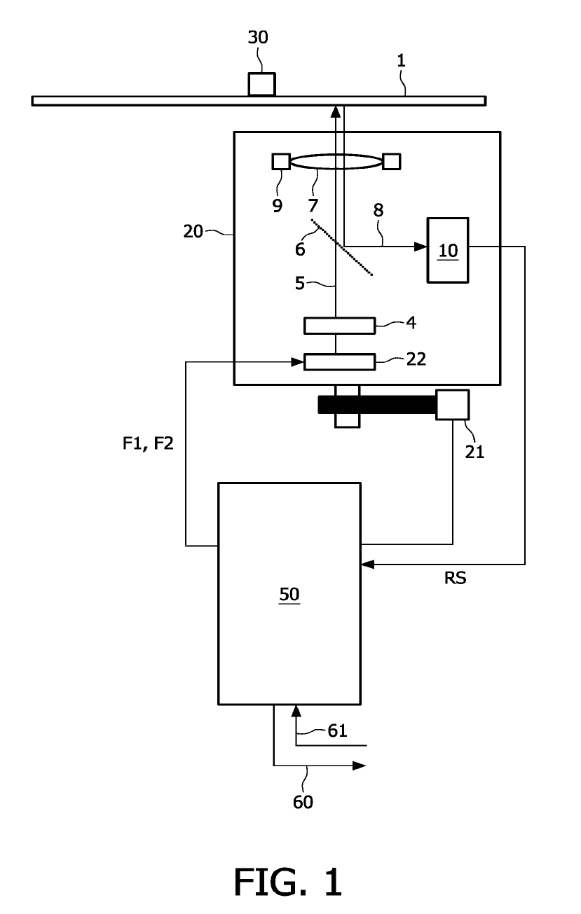

FIG. 1 shows an optical replaying/recording apparatus or an optical drive and an optical information carrier 1. The carrier 1 is fixed and rotated by holding means 30.

The optical carrier 1 comprises a material suitable for recording information by means of a radiation beam 5. The recording material may, for example, be of the magneto-optical type, the phase-change type, the dye type, metal alloys like Cu/Si or any other suitable material. Information may be recorded in the form of optically detectable effects, also called “marks” for rewriteable media and “pits” for write-once media, on the optical carrier 1.

The optical apparatus, i.e. the optical drive, comprises an optical head 20, sometimes called an optical pick-up (OPU), the optical head 20 being displaceable by actuation means 21, e.g. an electric stepper motor, a linear motor, or a DC motor. The optical head 20 comprises a photo detection system 10, a laser driver device (LDD), a radiation source 4, a beam splitter 6, an objective lens 7, and lens displacement means 9 capable of displacing the lens 7 both in a radial direction of the carrier 1 and in the focus direction.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals. The photo detectors are arranged spatially to one another and with a sufficient time resolution so as to enable detection of error signals, i.e. focus error FE and radial tracking error RE. The focus error FE and radial tracking error RE signals are transmitted to the processing means 50 where a commonly known servomechanism operated by using PID control means (proportional-integrate-differentiate) is applied for controlling the radial position and focus position of the radiation beam 5 on the carrier 1.

The radiation source 4 for emitting a radiation beam or a light beam 5 can for example be a semiconductor laser with a variable power, possibly also with variable wavelength of radiation. Alternatively, the radiation source 4 may comprise more than one laser. In the context of the present invention the term “light” is considered to comprise any kind of electromagnetic radiation suitable for optical recording and/or reproduction, such as visible light, ultraviolet light (UV), infrared light (IR), etc. The radiation source 4 is controlled by a laser driver device (LDD) 22 arranged for supplied the radiation source 4 with the appropriate time-dependent current. The driver device 22 is in turn controlled from the processing means 50. The processing means 50 controls the driver device 22 to emit the radiation beam 5 with a modulator frequency F1 or F2 as indicated in FIG. 1.

The processing means 50 also receives and analyses signals from the photo detection means 10, in particular optical response signals RS. The processing means 50 can also output control signals to the actuation means 21, the radiation source 4, the lens displacement means 9, and the rotating means 30, as schematically illustrated in FIG. 1. Similarly, the processing means 50 can receive data to be written, indicated at 61, and the processing means 50 may output data from the reading process as indicated at 60. While the processing means 50 has been depicted as a single unit i.e. a processor in FIG. 1, it is to be understood that equivalently the processing means 50 may be a plurality of interconnecting processing units positioned in the optical recording apparatus, possibly some of the units may be positioned in the optical head 20.

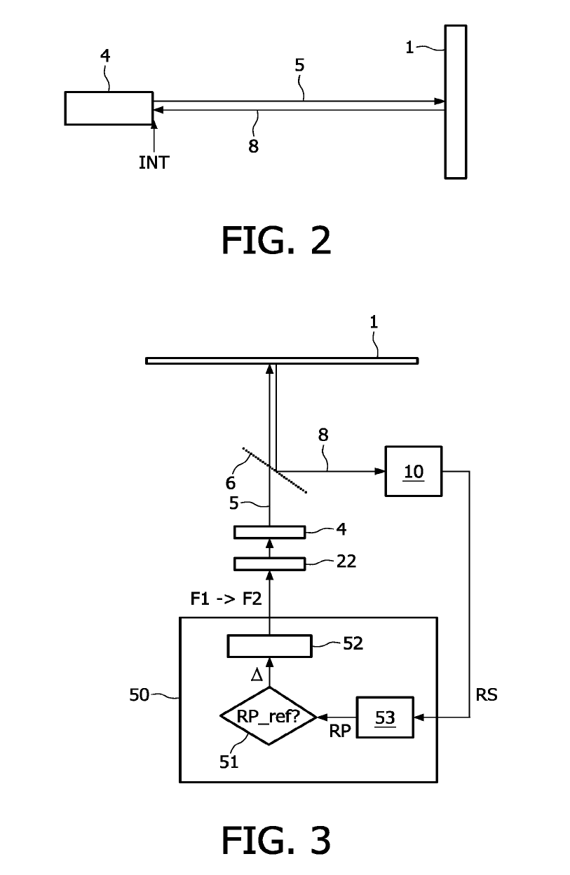

FIG. 2 is a schematic illustration of optical feedback in an optical drive with an optical carrier 1 showing only a few selected optical elements but nevertheless showing the basic principle of optical feedback. The radiation source 4, i.e. the laser, can be seen as a box with a specific electromagnetic (EM) standing wave pattern. A part of this wave 5 travels towards the carrier 1 and is reflected by the carrier 1 back as radiation 8. This path of radiation 5 and 8 can also be seen as a specific electromagnetic (EM) standing wave pattern. In optical storage, this is an unwanted component on the interface TNT of the radiation source 4 and should be reduced as much as possible by the light-path, e.g. by introducing beam splitters. Thus, when the reflected light 8 has a non-vanishing component on the interface INT of the radiation source 4 a rather complex process takes place. This is known as optical feedback.

When a data pattern is present on the carrier 1 there will be an instantaneous non-linear shift of signal level at the interface INT as is well known in the art of optical storage. This means that there will be a shifting of the shorter run-lengths within the EFM pattern. This is also known as an asymmetry (or beta) shift. Thus, in an extreme situation the result of this non-linear multiplicative process is that the short run lengths (2T, 3T etc. depending on the carrier format) will actually disappear making it very difficult or impossible to decode the information stored on the optical carrier 1. The optical feedback is always present under real conditions and will result in a coherent process on the interface INT.

FIG. 3 is a simplified diagram of an optical drive comprising a radiation source 4 capable of emitting a radiation beam 5 having a read power level modulated with a first modulator frequency F1. The radiation beam 5 is optically arranged to impinge on optical carrier 1, the carrier 1 having a significant birefringence, i.e. Δn≠0.

Polarizing beam splitting means (PBS) 6 are arranged for guiding the reflected beam 8 from the carrier 1 towards photo detection means 10. The photo detection means 10 is capable of outputting optical response signals RS from the optical carrier 1 to the processing means 50.

The processing means 50 is adapted for processing by sub-processor 53 the optical response signals RS received from the photo detection means 10 into one or more optical response parameters RP. The processing means 50 further comprises comparison means 51 arranged for monitoring if an optical response parameter RP is deviating from a pre-determined optical response parameter reference value RP_ref. The deviation is an indication of an optical feedback from the beam splitting means (PBS) 6 towards to the radiation source 4. If the deviation, indicated by the symbol Δ (Greek delta), is of a sufficient magnitude and/or character, the processing means 50 is further adapted for changing the first modulator frequency F1 of the radiation beam to a second modulator frequency F2 by a sub-processor 52 controlling the laser driver device 22. The processor 50 is thereby capable of decreasing the optical feedback by varying the modulator frequency from F1 to F2, normally by increasing the modulator frequency, i.e. F2 being larger than F1.

The optical response signals RS can represent information read from the optical carrier, e.g. the optical response signal could be the high frequency (HF) signal in one embodiment. The optical response parameters RP can then be e.g. an address locating a position on the optical carrier 1. If the address is in an erroneous format or otherwise unreadable, there can be a deviation within the context of the present invention. Alternatively, the frequency of such address errors can be monitored and if it exceeds a certain pre-determined level a deviation within the context of the present invention is present.

Alternatively, the optical response parameter RP can be an uncorrectable error in an information sequence read from the optical carrier 1. Information decoding of encoded data from an optical carrier 1 normally includes an error correcting step (ECC), but for severe errors even this correcting step cannot correct the errors and there may be a deviation within the context of the present invention. Alternatively, the frequency of such uncorrectable errors can be monitored and if it exceeds a certain pre-determined level a deviation within the context of the present invention is present.

Alternatively, the optical response parameter RP can be an asymmetry value (often termed beta, β) measured from the optical response signals (RS) i.e. the HF signal from the optical carrier 1. If the asymmetry exceeds a certain level, preferably on a time-averaged basis, there can be a deviation within the context of the present invention.

In one embodiment, the optical response signals RS can be compared directly with a reference value for the optical response signal itself. Thus, in that embodiment the optical response signal RS is equal to the optical response parameter RP and accordingly the function of sub-processor 53 is not needed. However, the sub-processor 53 will facilitate easier and less complex comparison with reference values so as to obtain an indication of an unacceptably high level of birefringence. In particular, the asymmetry value of the HF signal is a useful indicator for the level of birefringence in the optical carrier 1.

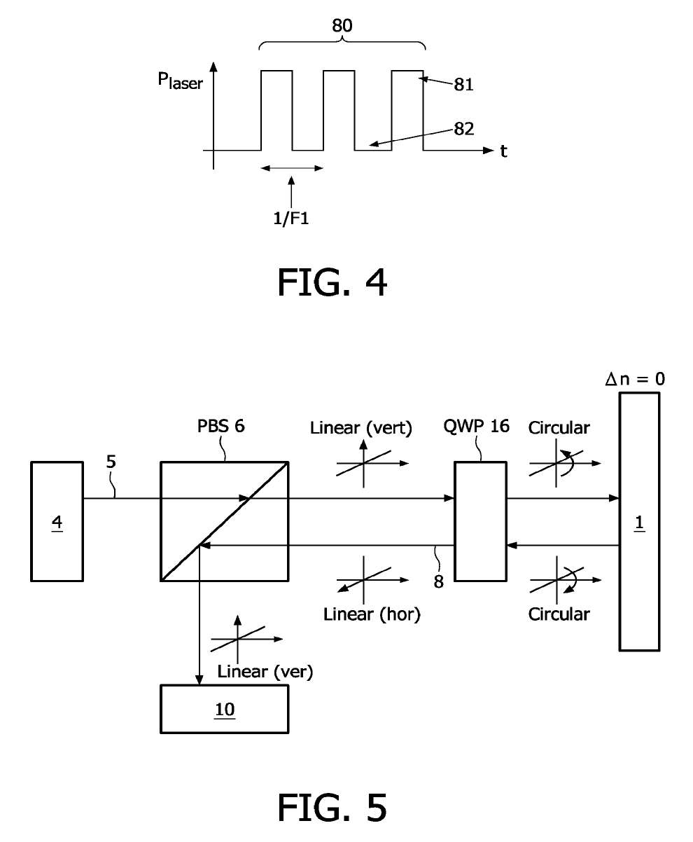

FIG. 4 is a simplified graph showing the modulated power output P_{Laser} in the emitted radiation beam 5 of an irradiation source 4. The power of the beam 5 is periodically modulated in a square wave pattern. It comprises a plurality 80 of pulses, each pulse having a period being the reciprocal of the modulator frequency; 1/F1. In FIG. 4, each pulse has a high constant level 81 and low level 82 where the radiation power is zero or close to zero. By turning the radiation power completely off in the low level 82 and changing the modulator frequency F1 it is possible by the teaching of the present invention to substantially decrease the optical feedback in the optical drive.

The modulator frequencies F1 and F2 have low and high limitations that should be mentioned. The modulator frequency cannot be chosen too low otherwise data decoding is not possible as it is known from the Nyquist sampling theorem. On the other hand, the modulator frequency may not be chosen too high because of the wiring between the discrete modulator or driver device 22 and the radiation source 4. Thus, a certain amount of parasitic inductance (golden rule 10 nH/cm) should be taken into account and it therefore becomes more and more difficult to switch e.g. a laser 4 on to 50 mA and off to 0 mA at higher and higher frequencies F1 and F2. Finally, there are electromagnetic shielding (EMC) limitations with respect to the rest of the optical drive and the surrounding environment. Thus, the emission can usually not exceed a specific level. Practically, the applied modulator frequencies F1 and F2 are in the range from 400 MHz to 500 MHz. However, the present invention can readily be applied outside of this frequency interval once the general principle of the invention is realized.

FIG. 5 is a schematic diagram of the optical path for an optical drive reading from a carrier 1 with no birefringence, i.e. Δn=0. Under real conditions there will usually not be exact zero birefringence, but in some cases it will be close to zero or alternatively effectively zero for practical considerations. The optical path is similar to FIG. 1 with the addition that a quarter wavelength plate (QWP) 16 is inserted in front of the carrier 1, and the focusing lens 7 in not shown for clarity in this Figure. In FIG. 5, the polarization state (linear or circular) and relative orientation (vertical or horizontal) is indicated at selected positions before and after the radiation beam 5 impinges on the optical carrier 1. After passing the polarizing beam splitter (PBS) 6, the radiation 5 is linearly polarized in the vertical direction. Upon traversing the QWP 17, the beam 5 is circularly polarized and likewise after reflection from the carrier 1 but then circularly polarized in the opposite rotational direction. After the reflected radiation beam 8 has passed the QWP 16, the polarization is again linear but now in the horizontal direction so as to facilitate beam separation in the polarizing beam splitter (PBS) 6. After the splitter 6, the reflected radiation beam 8 is completely reflected towards the photo detection means 10.

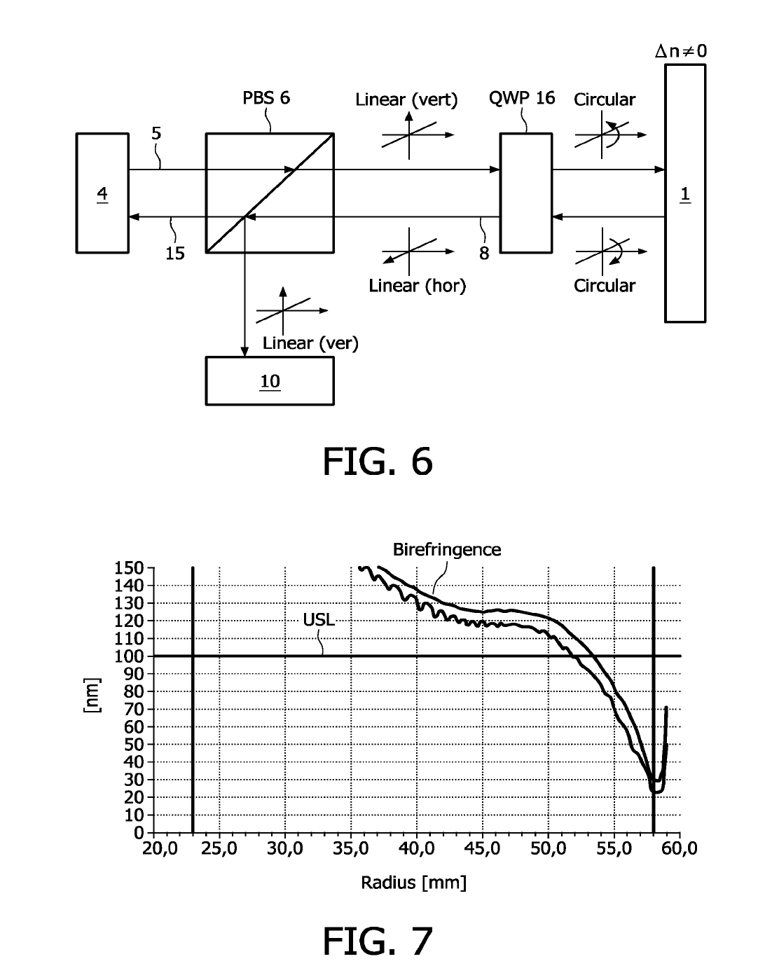

FIG. 6 is a schematic diagram of the optical path for an optical drive reading an optical carrier 1 with birefringence, i.e. Δn≠0. The optical path is similar to the optical path of FIG. 5, but due to the birefringence of the optical carrier 1 the polarization of the reflected radiation 8 will be distorted relative to the ideal situation shown in FIG. 5. Such a distortion can be an additional rotation of the polarization state. In general, it can be stated that birefringence introduces wave front error (usually expressed in nanometers). A further effect is the so-called optical leaking of power into the substrate of the optical carrier 1, i.e. a lowering of the reflectivity. The effect of the birefringence of the optical carrier 1 is seen at the polarizing beam splitter (PBS) 6, where the splitter 6 is unable to completely reflect the radiation 8 towards the photo detection means 10. Rather, the radiation 8 is split into two directions; one direction towards the photo detection means and another direction back towards the radiation source 4. The latter component represents the optical feedback 15 that is undesirable due to the negative influence on the emitted radiation 5 from the radiation source 4 as explained in connection with FIG. 2. Furthermore, the optical feedback 15 represents a power loss because this component cannot of course be measured by the photo detection means 10, and hence this results in lower signal intensity in the photo detection means 10.

FIG. 7 is a graph showing the birefringence across an optical carrier 1 of the DVD format. The birefringence is the relative birefringence measured in nanometers (nm) as indicated on the vertical axis on the graph of FIG. 7, and on the horizontal axis the radial position (mm) on the carrier 1 is indicated between 23 mm and 58 mm. The upper curve and lower curve of the birefringence indicate measured maximum and minimum values, respectively, according to ECMA standard for BD disks. The birefringence is above 100 nm for a radius below approximately 52 mm. The 100 nm is the upper specification limit (USL) marked by the horizontal line in the graph. Thus, this optical carrier 1 is for a large portion of the carrier out of the specification with respect to birefringence. Such an out-of-spec carrier or disk, also known in the art as a “horror disc”, is very likely to cause a fatal reading error unless the optical drive is provided with a compensational mechanism therefore. Indeed, the present invention provides an optical drive that enables an optical drive to compensate for such a birefringence on the optical carrier 1 in a very effective and cost-effective manner.

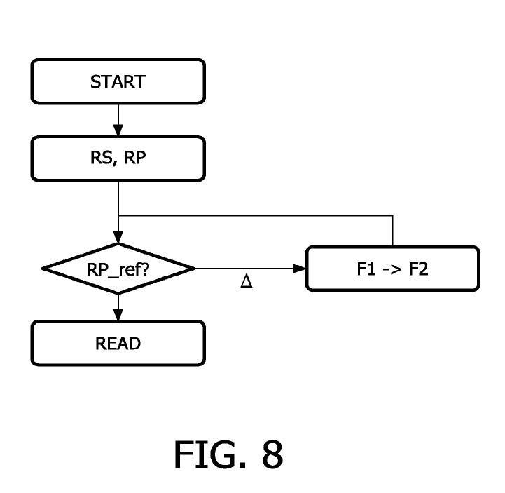

FIG. 8 is a flow-chart of a method according to the invention for operating an optical drive for reading information from an optical carrier 1, the method comprising the steps:

emitting a radiation beam 5 having a read power level 80 and 81 modulated with a first modulator frequency F1, said radiation beam being optically arranged to impinge on the optical carrier 1,

guiding by polarizing beam splitting means (PBS) 6 a reflected beam 8 from the carrier 1 towards photo detection means 10, said photo detection means being capable of outputting optical response signals RS, the two first steps is taken to be a part of the START box in the flow chart,

processing said optical response signals RS received from the photo detection means into one or more optical response parameters RP as shown in second box “RS, RP”,

monitoring if an optical response parameter RP is deviating from a pre-determined optical response parameter reference value RP_ref as indicated by the decision box “RP_ref?”, said deviation being indicative of an optical feedback 15 from the beam splitting means (PBS; 6) towards to the radiation source 4, and if a deviation occurs (marked by the symbol A, Greek delta) changing the first modulator frequency F1 of the radiation beam 5 to a second modulator frequency F2, indicated by the box “F1→F2”, so as to decrease the optical feedback 15 shown FIGS. 3 and 6. The closed loop feedback is limited to certain number of loops to ensure a stopping of the loop.

Finally, if no deviation is present between an optical response parameter RP and a pre-determined optical response parameter reference value RP_ref the method can proceed to the box READ.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An optical drive for reading information from an associated optical carrier (1), the optical drive comprising:
a radiation source (4) capable of emitting a radiation beam (5) having a read power level (80, 81) modulated with a first modulator frequency (F1), said radiation beam being optically arranged to impinge on the associated optical carrier (1),
polarizing beam splitting means (PBS; 6) arranged for guiding a reflected beam (8) from the carrier (1) towards photo detection means (10), said photo detection means being capable of outputting optical response signals (RS), and
processing means (50, 51, 52, 53) for processing said optical response signals (RS) received from the photo detection means (10) into one or more optical response parameters (RP), said processing means comprising comparison means (51) arranged for monitoring if an optical response parameter (RP) is deviating from a pre-determined optical response parameter reference value (RP_ref), said deviation being indicative of an optical feedback (15) from the beam splitting means (PBS; 6) towards to the radiation source (4), the processing means (52) further being adapted for changing the first modulator frequency (F1) of the radiation beam (5) to a second modulator frequency (F2) so as to decrease the optical feedback (15).

2. An optical drive according to claim 1, wherein the optical response signals (RS) are representing information read from the optical carrier (1).

3. An optical drive according to claim 2, wherein the optical response parameter (RP) is chosen from the group consisting of: an address locating a position on the optical carrier (1), an uncorrectable error in an information sequence read from the optical carrier (1), and an asymmetry value (beta) measured from the optical response signals (RS) from the optical carrier (1).

4. An optical drive according to claim 1 further comprising an auxiliary radiation source adapted for emitting an auxiliary radiation beam, said beam being optically arranged for impinging on the optical carrier (1) and resulting in a reflected beam towards the photo detection means (10).

5. An optical drive according to claim 1 further comprising auxiliary photo detection means for detection of reflected radiation representing information read from the optical carrier (1).

6. An optical drive according to claim 1, wherein the second modulator frequency (F2) is larger than the first modulator frequency (F1).

7. An optical drive according to claim 6, wherein the processing means (50) is arranged for increasing the modulator frequency (F1; F2) in a feedback loop so to minimize the deviation of an optical response parameter (RP) from a pre-determined optical response parameter reference value (RP_ref).

8. An optical drive according to claim 1, wherein the radiation beam (5) has a substantially square-wave power profile.

9. An optical drive according to claim 1, wherein the radiation beam (5) is optically arranged for passing the polarizing beam splitting means (PBS; 6) on the optical path towards the optical carrier (1).

10. Processing (50, 51, 52, 53) means for controlling an associated optical drive for reading information from an associated optical carrier (1), the associated optical drive comprising:
a radiation source (4) capable of emitting a radiation beam (5) having a read power level (80, 81) modulated with a first modulator frequency (F1), said radiation beam being optically arranged to impinge on the associated optical carrier (1), and
polarizing beam splitting means (PBS; 6) arranged for guiding a reflected beam (8) from the carrier towards photo detection means (10), said photo detection means being capable of outputting optical response signals (RS),
the processing means being adapted for processing said optical response signals (RS) received from the photo detection means into one or more optical response parameters (RP), said processing means comprising comparison means (51) arranged for monitoring if an optical response parameter (RP) is deviating from a pre-determined optical response parameter reference value (RP_ref), said deviation being indicative of an optical feedback (15) from the beam splitting means (PBS; 6) towards to the radiation source (4), the processing means (52) further being adapted for changing the first modulator frequency (F1) of the radiation beam (5) to a second modulator frequency (F2) so as to decrease the optical feedback (15).

11. Method for operating an optical drive for reading information from an optical carrier (1), the method comprising the steps:
emitting a radiation beam (5) having a read power level (80, 81) modulated with a first modulator frequency (F1), said radiation beam being optically arranged to impinge on the optical carrier (1),
guiding by polarizing beam splitting means (PBS; 6) a reflected beam (8) from the carrier (1) towards photo detection means (10), said photo detection means being capable of outputting optical response signals (RS),
processing said optical response signals (RS) received from the photo detection means (10) into one or more optical response parameters (RP),
monitoring if an optical response parameter (RP) is deviating from a pre-determined optical response parameter reference value (RP_ref), said deviation being indicative of an optical feedback (15) from the beam splitting means (PBS; 6) towards to the radiation source (4), and
changing the first modulator frequency (F1) of the radiation beam (5) to a second modulator frequency (F2) so as to decrease the optical feedback (15).

12. A computer program product being adapted to enable a computer system comprising at least one computer having data storage means associated therewith to operate an optical drive according to claim 11.
